(19) United States
(12) Patent Application Publication
(10) Pub. No.: US 2023/0311030 A1
(43) Pub. Date: Oct. 5, 2023

(54) ROLLER FILTRATION APPARATUS

(71) Applicant: DANMARKS TEKNISKE UNIVERSITET, Kongens Lyngby (DK)

(72) Inventors: Preben Bøje Hansen, Kongens Lyngby (DK); Peter Reimer Stubbe, Kongens Lyngby (DK)

(21) Appl. No.: 18/013,498

(22) PCT Filed: Jul. 2, 2021
(86) PCT No.: PCT/EP2021/068371

§ 371 Date: Dec. 28, 2022

(30) Foreign Application Priority Data
Jul. 2, 2020 (EP) 20183703.6

(51) Int. Cl. B01D 33/06; B01D 33/80; B01D 33/46

(52) U.S. Cl. CPC B01D 33/06; B01D 33/80; B01D 33/466

(57) ABSTRACT

An apparatus for the separation of dry matter and liquid from a medium includes: a plurality of press rollers and at least one pore roller, at least one separation chamber for receiving the medium, and at least one filtrate chamber defined in cross section by press rollers and the at least one pore roller. The apparatus is configured for establishing a relative negative pressure inside the pore roller interior, such that liquid in the medium is sucked into the pore roller interior, and for roller rotation such that during separation operation dry matter of the medium initially passes between the pore roller and a press roller when transferring from the separation chamber to the filtrate chamber, and subsequently passes between two press rollers, when exiting from the filtrate chamber.

### CROSS-REFERENCE TO RELATED APPLICATIONS

This application is the U.S. National Stage of PCT/EP2021/068371 filed on Jul. 2, 2021, which claims priority to European Patent Application 20183703.6 filed on Jul. 2, 2020, the entire content of both are incorporated herein by reference in their entirety.

### FIELD OF THE INVENTION

The present invention relates to the field of filtering, more precisely the present invention concerns a roller based apparatus for the separation of dry matter and liquid from a medium, i.e. a roller filtration apparatus, and the method of filtering.

### BACKGROUND OF THE INVENTION

Separation of dry matter from liquid is known in the art. Methods such as precipitation, centrifugation and filtering are commonly used for separation purposes in a vast number of industries. The latter separation method is relevant for the present invention.

An efficient method for separating dry matter from liquid was presented in WO 03/055570 and WO 2006/002638 disclosing filtration apparatuses providing an enclosed pressure regulated separation chamber wherein a suspension is accumulated on a filter which is passed through a set of solid impermeable rollers, whereby the pressure exerted by the rollers separates liquid from the suspension. The separation chamber defined by the rollers where divided into two compartments by the filter.

This roller based principle was improved in WO 2008/131780 where a filtration apparatus based on one or more pore rollers was disclosed. A pore roller is a roller with a surface comprising pores allowing permeability for fluid, in fluid contact with a channel for guiding liquid to a filtrate outlet. Thus, the pressure exerted by the rollers guides the liquid inside the pore roller through the pores in the surface. The end products are the filtrated liquid and a dry filter cake.

Additional improvements of the pore roller based filtration principle were presented in WO 2014/198907 and WO 2017/202934. For example, WO 2017/202934 discloses a scraping element to wipe off the inside surface of a filter shell, surrounding the filter roller, and in another embodiment, WO 2017/202934 discloses use of vacuum in the pore rollers for aiding the filtering.

The documents WO 03/055570, WO 2006/002638, WO 2008/131780, WO 2014/198907 and WO 2017/202934 are hereby incorporated by reference in their entirety.

### SUMMARY OF THE INVENTION

The present disclosure provides an improved roller filtration device for separation of dry matter and liquid from a medium, comprising at least one separation chamber for receiving the medium, and at least one filtrate chamber defined in cross section by press rollers and at least one pore roller, such that during separation operation, dry matter of the medium first passes between the pore roller and a press roller when transferring from the separation chamber to the filtrate chamber, and subsequently passes between two press rollers when exiting from the filtrate chamber. Hence, the separation operation implies and is occurring when the pore roller and press rollers are in rotation.

The configuration of the separation chamber and the filtrate chamber facilitates increased separation efficiency, and consequently reduced risk of rewetting, and improved uniformity and higher quality of the resulting separated dry matter and liquid filtrate. Furthermore, the configuration of the present roller filtration device provides a more simple and maintenance efficient device, thereby enabling stable, long-term operation, where parts may easily be exchanged. The configuration further facilitates a higher degree of selective separation. Hence, separation of different types of solids may be obtained.

The configuration of the separation chamber and the filtrate chamber further has the advantage that the orientation of the device, including the rollers of the device, is flexible, because the separation process does not depend on gravity. Hence, the device and the rollers may be oriented vertically, horizontally, or at any angle therein between, during operation.

A first aspect of the disclosure relates to an apparatus for the separation of dry matter and liquid from a medium, comprising:
a plurality of press rollers and at least one pore roller,
at least one separation chamber for receiving the medium,
at least one filtrate chamber defined in cross section by press rollers and the at least one pore roller,
wherein the apparatus is configured:
for establishing a relative negative pressure inside the pore roller interior, such that liquid in the medium is sucked into the pore roller interior, and
for roller rotation such that during separation operation dry matter of the medium initially passes between the pore roller and a press roller when transferring from the separation chamber to the filtrate chamber, and subsequently passes between two press rollers when exiting from the filtrate chamber.

A second aspect of the disclosure relates to a method for separating dry matter and liquid from a medium, comprising the steps of:
passing the medium between at least one set of abutting pore roller and press roller, thereby obtaining a first solid fraction and a first liquid fraction, and
passing the first solid fraction through at least one set of abutting press rollers, thereby obtaining a second solid fraction and a second liquid fraction.

In a preferred embodiment, the apparatus of the first aspect is adapted for carrying out the method according to the second aspect.

In another preferred embodiment, the method includes the steps of providing the apparatus according to the first aspect, and separating the dry matter and liquid from the medium within the apparatus.

### BRIEF DESCRIPTION OF DRAWINGS

The invention will in the following be described in greater detail with reference to the accompanying drawings.

FIG. 1 shows a cross sectional top view of an embodiment of the filtration device according to the present disclosure, comprising three press rollers 1 and one pore roller 2;

FIG. 2 shows a side view of an embodiment of the filtration device according to the present disclosure comprising six press rollers and two pore rollers;

FIG. 3 shows a cross sectional top view of the filtration device of FIG. 2 along the indicated section B-B;

FIG. 4 shows a cross sectional side view of the filtration device of FIG. 2 along the cross sectional view indicated as A-A;

FIG. 5 shows an embodiment of a transport unit according to the present disclosure, where the transport unit is further a grinder unit, and in the form of a push lawn mower blade grinder;

FIG. 6 shows an embodiment of a filtration unit according to the present disclosure in cross sectional view as grey scale (A), and as line drawing (B);

FIG. 7 shows an embodiment of a filtration unit according to the present disclosure in perspective side view (A), and in cross sectional view (B) along the section A-A shown in (A);

FIG. 8 shows an embodiment of a grinder unit according to the present disclosure, where (A) shows a side view; (B,C) show a cross sectional view along the longitudinal section A-A (to the right) and a cross sectional view across the cylinder (to the left); (D) shows a grey scale (left) and line drawing (right) of an embodiment of a fastening means, e.g. a locking nut, for attaching the parts of the grinder unit;

FIG. 9 shows an embodiment of a grinder unit according to the present disclosure as grey scale (A), and as line drawing (B);

FIG. 10 shows an embodiment of a cylindrical filter configured as liquid outlet according to the present disclosure, where (A) shows a side view; (B,C) show a cross sectional view along the longitudinal section A-A (to the right) and a cross sectional view across the cylinder (to the left); (D) shows a grey scale (left) and line drawing (right) of an embodiment of a fastening means, e.g. a locking nut, for attaching the parts of the cylindrical filter;

FIG. 11 shows an embodiment of a pre-grinder unit or a grinder unit according to the present disclosure, in perspective view (A), and in cross sectional view (B);

FIG. 12 shows an embodiment of a filtration unit according to the present disclosure including a liquid or water line;

FIG. 13 shows an embodiment of a filtration unit according to the present disclosure including a liquid or water line;

FIG. 14 shows embodiments of end plates configured as sealant for the roller ends according to the present disclosure;

FIG. 15 shows a cross sectional top view of an embodiment of the filtration device according to the present disclosure comprising six press rollers and two pore rollers;

FIG. 16 shows an embodiment according to the present disclosure of the feed inlet, grinder, and transport unit, as seen in a cross sectional side view;

FIG. 17 shows an embodiment according to the present disclosure of the filtration device in perspective view, where the diameter (Ø) of the filtration device housing is exemplified to be 1140.00 mm; and

FIG. 18 shows an embodiment according to the present disclosure of filtration device, as seen in a perspective side view.

### DETAILED DESCRIPTION OF THE INVENTION

The invention is described below with the help of the accompanying figures. It would be appreciated by the people skilled in the art that the same feature or component of the device are referred with the same reference numeral in different figures. A list of the reference numbers can be found at the end of the detailed description section.

Separation Efficiency

Examples of media which are advantageously separated include suspensions from the biomass, food and beverage industries. For example, biomass waste materials in the form of manure, orange peels, and coffee grounds may be separated, and thereby upgraded into a solid fraction suitable e.g. as biogas feedstock. Also, raw materials for food/beverage products, may be upgraded into a higher value product. For example juice comprising fruit pulp or sludge, crushed grape pulp for wine, mask for beer, eatable oils suspensions, and yeast and bacteria containing suspensions may be separated, and thereby upgraded into a product with a lower concentration of solids, e.g. a lower concentration of pulp or microorganisms. Another example of upgraded separated products include orange peels, where it is advantageous to separate the white solid parts (albedo) from the orange parts (flavedo) due to different application purposes. A further example of upgraded separated products include mango or mango waste materials, where it is advantageous to separate the different phases: the free liquid juice phase, the partly solid flesh/pulp, the skin/peel, the husk, and the seed/stone. Further examples include beans and apples.

A medium for separation comprises a mix of one or more solid and liquid parts, and the medium may further be characterised as a suspension, dispersion, paste, and/or slurry depending on the dry matter content, the ratio between solid and liquid parts, and the stability of the solid particles within the liquid part. The separation into the corresponding solid parts and liquid parts may be obtained by one or more filtration steps. However, complete separation is difficult to obtain. Hence in practice, the separated solid fraction, or the dry filter cake, will comprise both solid and liquid parts, but with a reduced content of liquid compared to the original mixture, and the separated liquid fraction, or the filtrated liquid, will comprise both solid and liquid parts, but with a reduced content of solid compared to the original mixture.

The separation efficiency, or the filtration efficiency, will depend on the starting medium and the separation method. For example, the size of the solid particles within the mixture in combination with the size of the filter mesh openings, will determine the filtering efficiency. Complete separation implies that the separated liquid fraction, also referred to as the filtrate or filtrated liquid, is a liquid fraction essentially void of solid substances. Similarly, complete separation implies that the separated solid fraction, also referred to as the dry filter cake, is essentially void of liquid parts.

By use of the device according to the present disclosure, a surprisingly high separation efficiency may be obtained. In an embodiment of the disclosure, the separated solid fraction has a dry matter content of at least 50 vol %, such as above 55, 60, 65, 70, 75, 80, 85, 90, 95, or 97 vol %.

The separated solid fraction will be prone to rewetting. Thus, following the separation steps, the separated solid fraction and liquid fraction are advantageously kept physically apart. Rewetting of the solid fraction will correspond to a decrease in the separation efficiency.

For efficient separation, the separation method, e.g. the speed of press rollers and pore rollers, is adapted to the starting medium. Hence, the apparatus advantageously comprises a data processing unit configured for receiving input on the medium received within the separation chamber, e.g. via a communication device, such as a wireless device which may be a tablet, smart phone, or a laptop.

In an embodiment of the disclosure, the apparatus comprises a data processing unit configured for receiving input on the received medium, and optionally controlling the rotation means.

A further aspect to the separation efficiency is the separation selectivity. For example, a medium for separation may comprise a mix of two or more types of solid parts and liquid parts, such as a orange peels comprising white solid parts (albedo), orange coloured parts (flavedo), and liquid juice, or a mango comprising seed, husk, juice, flesh, and peel. The configuration of the separation method may hence promote a higher concentration (or selectivity) of e.g. the white solid parts in the separated solid fraction.

Chamber Configuration

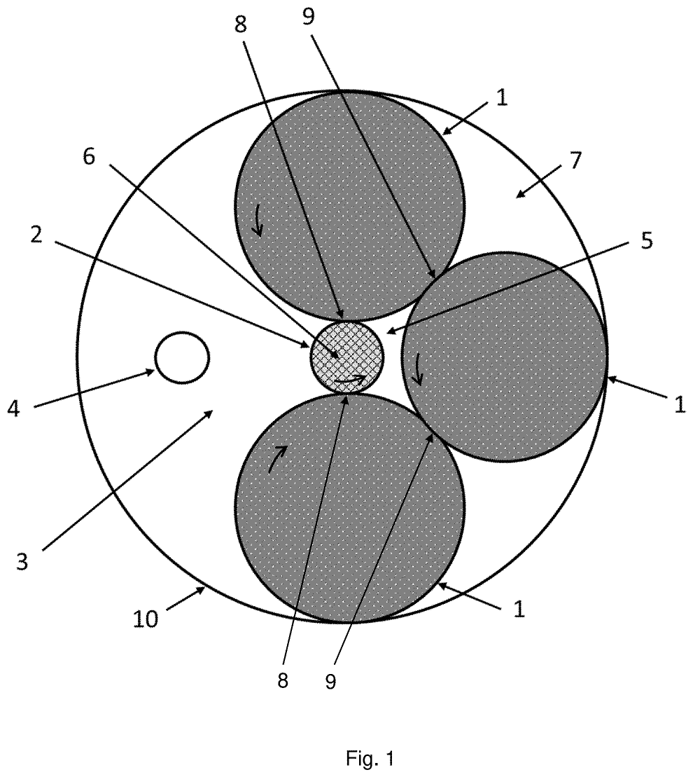

FIG. 1 shows an embodiment of the device according to the present disclosure, where the device or apparatus comprises a separation chamber 3 and a filtration chamber 5, defined by the arrangement of the rollers within a housing 10, exemplified as a circular or cylindrical housing, as seen in the cross sectional view of FIG. 1.

Feed Inlet

The device, or apparatus, comprises a separation chamber 3 adapted for receiving the medium to be separated. The medium may for example be supplied to the separation chamber via a feed inlet 4, which may further be adapted to facilitate a continuous or a batch controlled feed of the media to the separation chamber. A continuous feed of medium via the feed inlet may be obtained by use of a transport unit, such as a screw conveyor. For example the feed inlet may be a tubular structure as seen in FIG. 1, where the feed enters the separation chamber via a tubular end opening (i.e. the feed is transported in parallel with the tube), and/or the feed enters the separation chamber via openings in the tubular circumferential wall (i.e. the feed is transported radially out of the tube).

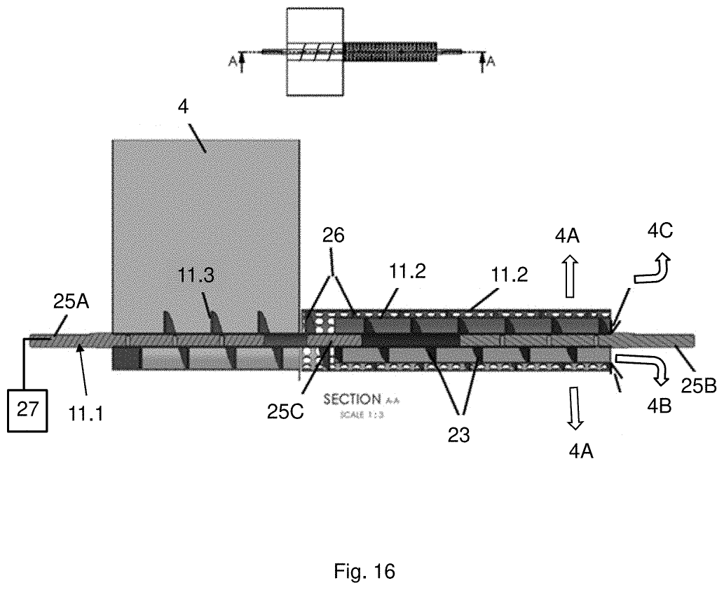

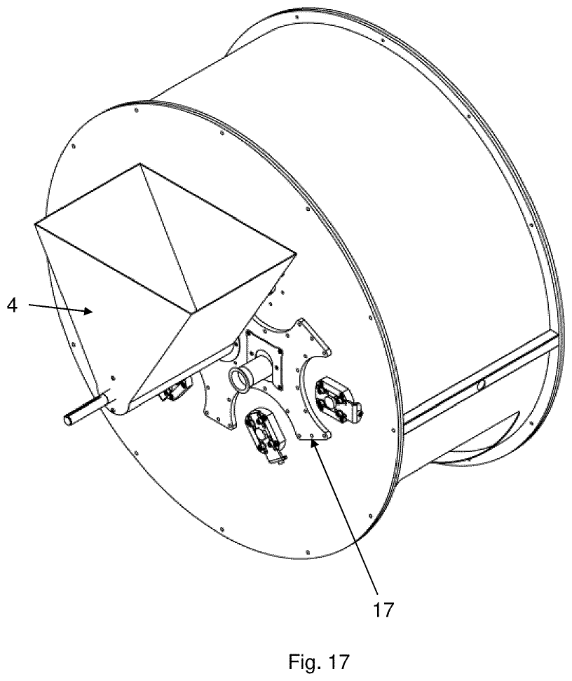

In addition, or alternatively, the feed may be obtained by gravity. FIGS. 16-18 show an embodiment of a partly gravity driven feed, where the feed inlet 4 is a funnel and/or hopper unit oriented perpendicular to the transport unit. The feed inlet may therefore comprise a container or storage cell, where the material is stored before filtration. Further, the feed inlet may be supplied with a low addition of fluids, or even no fluids, to facilitate the feed to flow and be transported into the device, as this is enabled by the flowability of the material and gravity. For example, the feed may be supplied with gas, air, or liquid for e.g. aerating/drying the feed, or washing the feed.

In an embodiment of the disclosure, the separation chamber comprises a feed inlet. In a further embodiment, the feed inlet comprises a transport unit, such as a screw conveyor.

The feeder advantageously generates an overpressure through the feed inlet and into the separation chamber 3, which thereby may accelerate the separation rate. The overpressure is e.g. generated by gravity and/or the rate/speed of the grinder unit and/or transport unit, e.g. the rotation speed and/or shape of the screw conveyor or transport spiral.

Grinder Unit

The present disclosure further relates to a grinder unit. A grinder unit is configured for producing a grinded product, i.e. to cut or comminute the solid parts of the feed into a smaller and more uniformly sized particles, and/or to deagglomerate particle agglomerates, e.g. to split apart smaller particles adhering to the surface of larger particles. The comminution may for example be obtained using cutting knives, such as rotating knives, ball milling, and roller mills.

The presently disclosed separation device may be used for separating different types of media into dry matter and liquid, where the media may comprise solids of very different particle sizes and shapes. To ensure a uniform separation efficiency, the separation chamber and/or the feed inlet are advantageously in fluid communication with the presently disclosed grinder unit.

In an embodiment of the disclosure, the separation chamber and/or the feed inlet is in fluid communication with the grinder unit. In a further embodiment, the grinder unit is selected from the group of: rotating knives/blades, ball mills, and roller mills.

To improve the simplicity and cost efficiency of the device, the grinder unit is advantageously a combined transport unit and grinder unit. For example, the transport unit may be a modified screw conveyor, which acts as a grinder unit due to a blade configuration or blade rotation similar to a push lawn mower. Thus, the grinder unit may be simply detachably mounted in the device, e.g. by a clamp, such that it is easily detached for maintenance, and reattached after maintenance. The grinder unit may further easily be replaced with a cleaning unit, comprising a feed of cleaning means, such as an acidic or basic solution or fluid.

The presently disclosed grinder unit may be used separately, as well as in combination with the separation apparatus of the present disclosure, or in combination with other apparatuses.

FIG. 5 shows an embodiment of a grinder unit according to the present disclosure, in the form of a push lawn mower blade grinder. The grinder unit is rotatable around the longitudinal axis, and may be rotated in both directions, optionally successively in the two directions in a predefined pattern, such that simultaneous transport and grinding is obtained. The rotation further reduces the risk of accumulation or clogging of feed material within the feed inlet, as the inner walls of the inlet are scraped by the blades moving in either directions. The lawn mower grinder blade configuration further has the advantage that the feed transport flow mainly occurs radially towards the longitudinal axis, in contrast to a traditional screw conveyor where the transport flow occurs mainly occurs radially away from the axis and towards the boundary surrounding the screw conveyor. Hence, the pressure of the feed is mainly towards the longitudinal axis, which as shown in FIG. 5 may be shaped as a longitudinal tube. Due the higher compression resistance of a tube compared to the tensile strength, the mechanical stability of the feed inlet will also be improved. Alternatively, the grinder blades are configured in the manner of a traditional screw conveyor, such that the transport flow occurs mainly radially away from the axis and towards the boundary surrounding the screw conveyor. Hence, the feed is mainly transported and pressed against the surrounding surface, and further transported through openings in the surrounding surface, which may have the advantage of a more efficient transport and filtration, as described below. For example, the grinder and/or transport unit may include a wet sieve cutter 26, as illustrated in FIG. 16, which is a surrounding surface including multiple openings suitable for transferring the material feed to be separated through.

In an embodiment of the disclosure, the transport unit is further a grinder unit, such as a push lawn mower blade grinder. In a further embodiment, the transport unit comprises a longitudinal/elongated tube.

The transport unit advantageously comprises a liquid inlet and/or outlet. For example, efficient grinding may require a certain amount of liquid present. Hence, additional liquid may be supplied to the feed through a liquid inlet, or removed from the feed through a liquid outlet. Optionally, the liquid inlet and liquid outlet is the same, and only differs by the direction of the liquid flow. The direction of the liquid flow may be controlled by any known flow regulation means. For example, liquid will flow out of the feed if the pressure at the liquid inlet/outlet is below the pressure at the feed unit, e.g. if the pressure at the outlet is negative relative to the feed, such as vacuum. To ensure only liquid flows through the liquid inlet and/or outlet, the inlet/outlet may comprise a filtering unit.

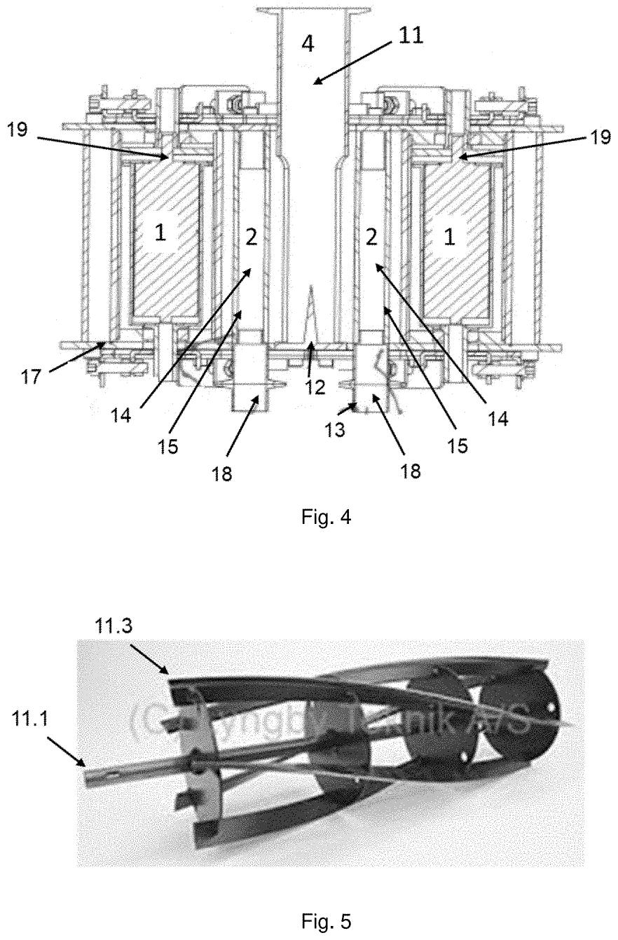

The longitudinal tube of the transport unit advantageously comprises the liquid inlet and/or outlet and filtering unit. Hence, the pressure at the liquid inlet/outlet may be easily controlled, and e.g. be set to vacuum. FIG. 4 shows an embodiment of a transport unit, comprising a transport/grinder unit 11, where the lower part of a longitudinal tube comprises a liquid inlet and/or outlet 12.

In an embodiment of the disclosure, the transport unit comprises a liquid inlet and/or outlet. In a further embodiment, the liquid inlet and/or outlet is configured to have a relative negative pressure, such as vacuum.

As seen in FIG. 5, the grinder unit may further comprise a central tube, where the central tube is a cylindrical filter 11.1 configured as the liquid outlet. For example, the cylindrical filter, defining a cylindrical axis, may comprise a cylindrical wall having a porosity suitable for separating solids from liquids, such that only the liquid part is transferred through the tube wall and enters into interior the interior of the tube. From the interior of the tube, the liquid may be further transferred out of the grinder system, e.g. removed and discharged in a direction along the cylindrical axis. Hence, the grinder unit comprises a liquid outlet. Hence, when the feed material is introduced and transported in the longitudinal axis, an initial separation step occurs, where an initial liquid fraction is transported through the cylindrical filter and enters the interior of the cylindrical filter, while the residual feed mixture of liquid and solids parts are transported into the separation chamber. An initial separation step is especially advantageous when the feed material has a high initial liquid content, or when the feed material comprises large, hard chunks, or has a high initial particle size.

In an embodiment of the disclosure, the grinder unit comprises a cylindrical filter configured as liquid outlet.

The efficiency of the initial separation step will depend on several factors, e.g. if the liquid outlet or the interior cylindrical filter is configured to have a relative negative pressure, as well as the pressure difference across the filter, the type of filter, and the pore size or mesh size of the cylindrical filter. The more efficient the initial separation step, the more efficient the overall separation of the apparatus. Highly efficient initial separation is observed for ceramic filters, such as carbide filters, e.g. silicon carbide (SiC), which due to their high mechanical strength allows for high feed rates, and high feed pressures, as well as high pressure differences across the cylindrical filter. The ceramic filters further has the advantage that they are self-supporting, and may withstand high radial pressure from a rotation mean, such as a drum motor.

In an embodiment of the disclosure, the cylindrical filter is a ceramic filter, such as a silicon carbide (SiC) filter with a pore size between 0.01 μm-2 cm, more preferably 0.01-0.5 μm, more preferably between 0.1-0.3 μm, such as 0.2 μm.

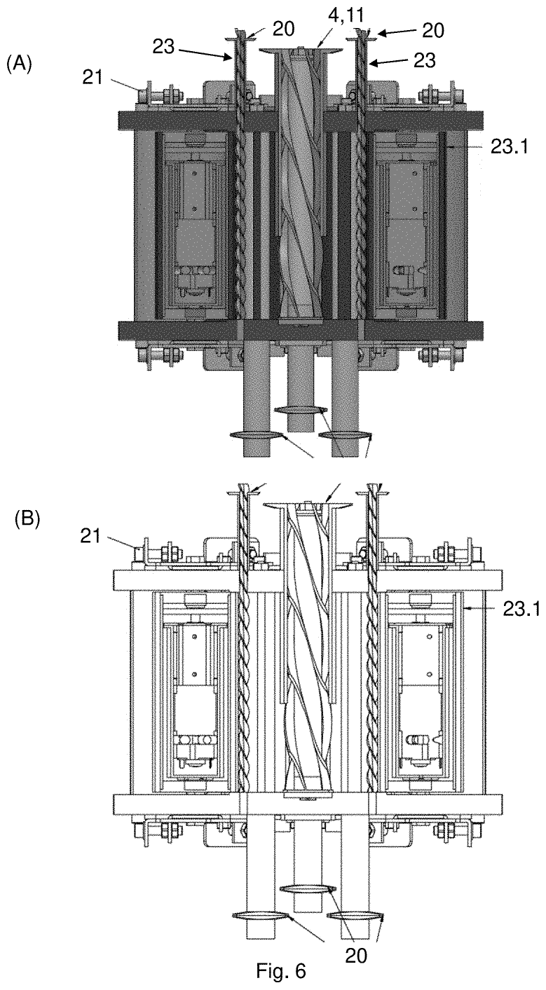

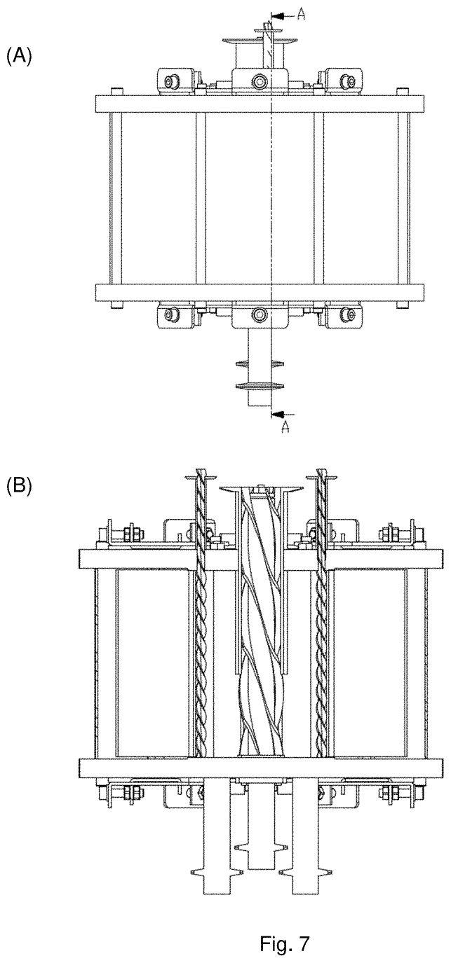

To reduce the risk of clogging along the cylindrical filter, and for efficient grinding of the feed material, the cylindrical filter is advantageously rotatable, and the grinder unit further comprises one or more blades 11.3 extending radially outwardly from the cylindrical axis and in a direction along the cylindrical axis. The blades may be physically separated from the cylindrical filter, as for the push lawn mower configuration in FIG. 5, or in physical communication or attached to the cylindrical filter, as illustrated in FIGS. 6-9. The blades may further extend radially outwardly at a perpendicular angle, as indicated in FIG. 5, or at a different angle, as indicated in FIG. 6.

In an embodiment of the disclosure, the cylindrical filter is adapted to be stationary and/or rotatable in both directions around the cylindrical axis. In a further embodiment of the disclosure, the apparatus comprises one or more blades extending radially outwardly from and in a direction along the cylindrical axis.

For efficient grinding and pressure distribution of the feed within the grinder, the one or more blades advantageously extend along the cylindrical axis or the cylindrical filter in a helical pattern, as illustrated in FIGS. 5-9. Further advantageously, the grinder comprises between 2-8 blades, such as 4 blades, as shown in FIG. 5, and the blades are adapted to be rotatable around the cylindrical axis.

In an embodiment of the disclosure, the one or more blades extend along the cylindrical axis in a helical pattern. In a further embodiment, the apparatus comprises between 2-8 blades, preferably 4 blades. In a further embodiment, the blades are adapted to be rotatable in both directions around the cylindrical axis.

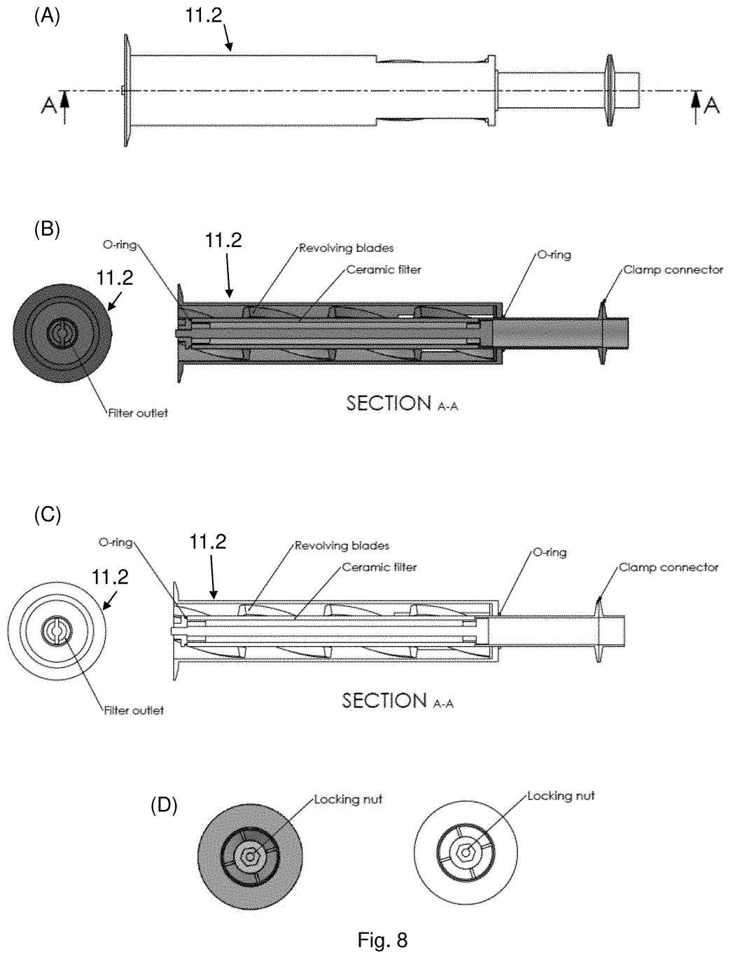

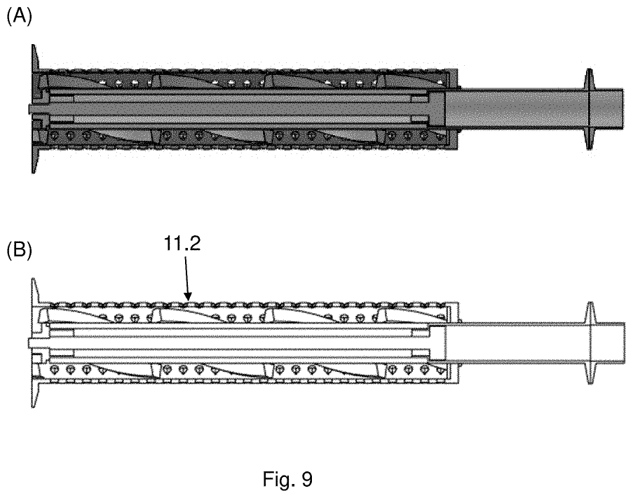

For further efficient grinding and pressure distribution, the grinder unit further comprises an outer grinder filter 11.2 surrounding the blades, such that the revolving blades are crushing and grinding the feed material by the blades as well as crushing and grinding the feed material against the outer filter, as seen in FIGS. 8B-C and 16. Further advantageously, the outer grinder filter comprises a pore size or mesh size to facilitate a second initial separation, such as a pore size or mesh size between 0.2 μm-2 cm, preferably between 0.5 μm-5 mm, or between 1-10 mm. The outer grinder may further comprise one or more protrusions acting as an additional grater, as indicated in FIG. 9A-B, thereby facilitating further grinding of the solid feed material.

In an embodiment of the disclosure, the grinder unit comprises an outer filter surrounding the blades. In a further embodiment, the outer grinder filter is a ceramic filter with a pore size between 0.2 μm-2 cm, preferably between 0.5 μm-5 mm, or between 1-10 mm, more preferably between 3-7 mm, such as 5 mm.

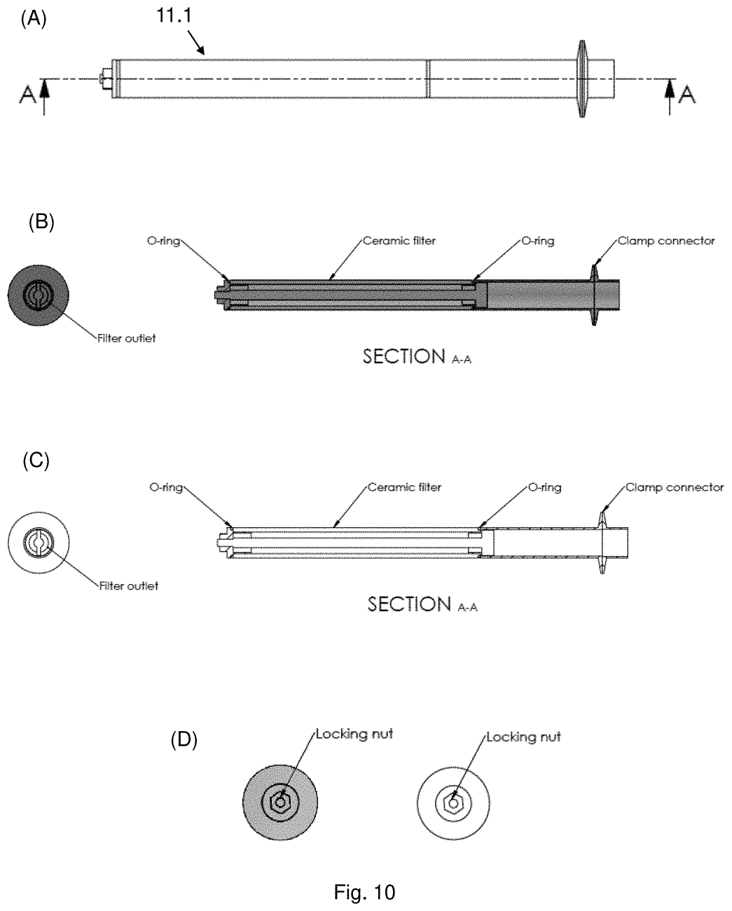

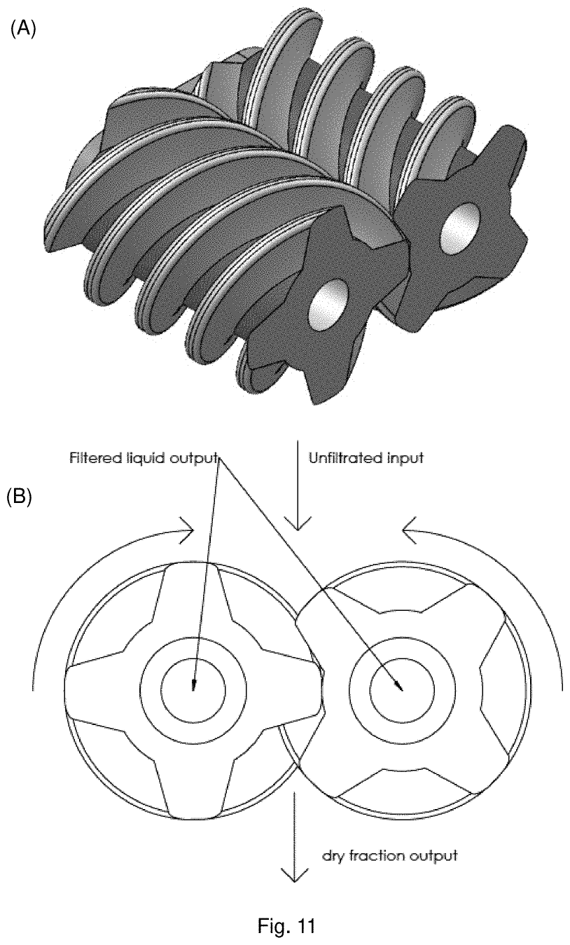

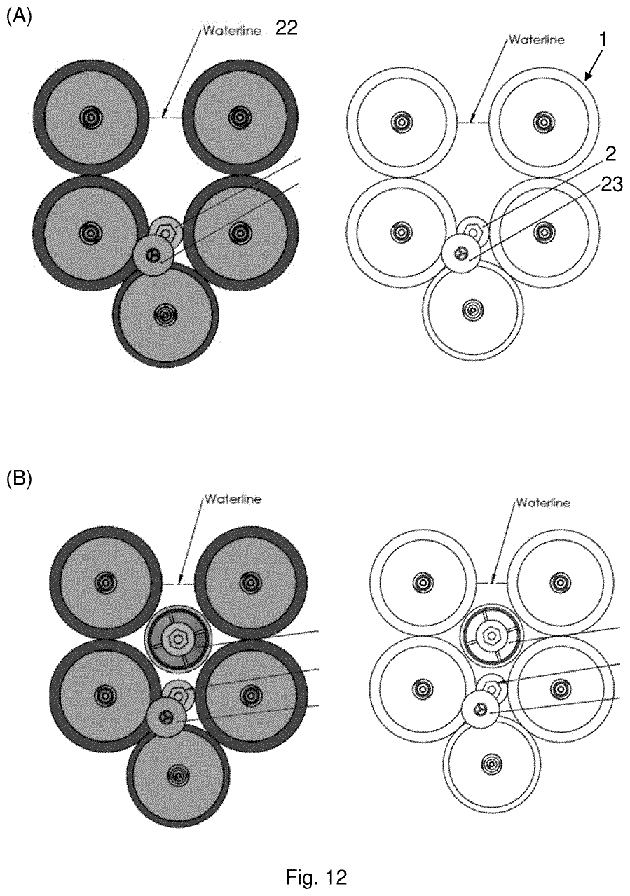

Both the cylindrical filter 11.1 and the outer grinder filter 11.2 may be configured to have a relative negative pressure, such as vacuum, at the interior filter side or inner lumen to improve the initial separation. This may be obtained due to the pore size or mesh size of the filters. Further, this may for example be obtained as illustrated in FIG. 10A-B, by a cylindrical filter 11.1 being free to rotate on stainless steel shims, e.g. via fastening means such as locking nuts shown in FIG. 10D, while O-rings at each ends of the cylindrical filter seals the unit making it possible to generate vacuum inside the system, while maintaining easy access for service and maintenance. In addition, or alternatively, vacuum may be applied at an end of the filter, such as at the clamp end, as e.g. illustrated in 10C. Correspondingly, the outer grinder filter 11.2 may be configured to have a relative negative pressure, as illustrated in the corresponding FIG. 8. In addition, or alternatively, a vacuum generator 27 may be fluidly attached to the cylindrical filter, as e.g. illustrated in FIG. 16.

In an embodiment of the disclosure, the cylindrical filter and/or the outer grinder filter is configured to have a relative negative pressure, such as vacuum.

The grinder unit, including the cylindrical filter and the outer grinder filter, are advantageously detachably attached to the housing or the end plates, e.g. by use of fastening means such as clamps 20, as illustrated in FIG. 6. Similarly, other parts of the apparatus, e.g. the press rollers, pore rollers, and scraping elements may be detachably attached by use of e.g. clamps. The fastening means provide the advantage of easy assembly and disassembly, e.g. for service and maintenance of the apparatus. To facilitate easy alignment of the parts, the fastening means advantageously comprises slidable adjusters 21, as illustrated in FIG. 6.

In an embodiment of the disclosure, the rollers, and/or grinder, and/or scraping elements are detachably attached to the housing or the end plates, such as by use of clamps, optionally in combination with one or more slidable adjusters.

For further efficient grinding and pressure distribution, the grinder unit advantageously is or comprises a pre-grinding unit, as illustrated in FIG. 11. The pre-grinding unit may comprise two feedscrews forming a press around a central and concentric cylindrical filter, advantageously a ceramic filter. The screws are rotating in opposite direction, i.e. against each other as indicated by arrows in FIG. 11B, such that the feed material is pressed against the screw blades or walls, and a liquid fraction may pass through into the central cylindrical filter.

In a further embodiment of the disclosure, the transport unit is a combined grinder unit and transport unit, in extension of each other, as illustrated in FIG. 16. Hence, by adapting the distances between the grinder unit and transport unit, the apparatus may be adapted to any type of feed material, including feeds differing in consistency and hardness.

In FIG. 16, the feed 4 first enters the grinder unit, where the grinder unit blades 11.3 are present. The grinder blades grind the feed between the blades, as well as against the wet sieve cutter 26, corresponding to an outer grinder filter 11.2 adapted with openings for transferring the feed into the separation chamber 4A. Hence, the grinder unit blades may act as grinders, transport means, as well as cleaning means or scrapers against the wet sieve cutter.

The transport unit is in extension of the grinder unit, and comprises similar or identical spiral or helical blades, e.g. screw conveyor blades, in linear extension of the grinder unit blades, for transporting the flow mainly radially away from the axis and towards the wet sieve cutter boundary surrounding the screw conveyor. Similarly to the grinder unit, the transport unit may comprise a cylindrical filter 11.1 and an outer grinder filter 11.2, as illustrated in FIG. 16.

The rotation, transport unit and/or grinder unit may be driven by a motor by one or more shafts 25, as illustrated in FIG. 16. For example, a first shaft 25A may drive the grinder unit (left part in FIG. 16), and a second shaft 25B may drive the transport unit (right part in FIG. 16). The first and second shafts may be connected by a shaft connector element 25C, such that the rotation direction and speed of the two shafts are independently controlled. The cylindrical filter 11.1 and outer grinder filter 11.2 may also be driven or rotated, either actively by a motor/shaft, or passively by the rotation induced by the transported feed.

Advantageously, the shafts 25A and 25B are adapted to be independently stationary and/or rotatable in both directions around the cylindrical axis. By controlling, and particularly changing, the rotation rates and rotation direction of the shaft sections, and optionally the filters, the shear forces within the grinder unit and transport unit may be independently controlled, as well as the residence time of the feed within each of the units. Hence the initial separation occurring within the grinder and transport unit may be improved. For example, the rotation speed may be controlled by rotating the left part of the shaft 25A in FIG. 16 in one direction, and the right part of the shaft 25B in the opposite direction. In addition, or alternatively, the left and right part of the shaft may rotated at different speeds. This further enables control of the speed and the shear forces present in the device. Further this facilitates digital monitoring and control.

As illustrated in FIG. 16, the shafts advantageously is connected with and is assembled as part of the feed inlet, grinder, transport unit, vacuum generator 27, and a cleaning unit 23. The cleaning unit may be in the form of a scraping element, such as a helix shaped scraping element, extending in the same direction as the grinder. The vacuum generator may be a separate pump, as illustrated in FIG. 16, or a vacuum generated by the changes in the shear forces within the grinder/transport unit, and the associated temperature changes. Hence, changes in shear forces and temperature may induce a relative negative pressure across the cylindrical filter (TMP), or a vacuum within the cylindrical filter associated with the shaft.

The feed 4A which enters the separation chamber 3, may be discharged from the tubular grinder/transport unit in the radial direction, whereby it enters the separation chamber through the surrounding tubular wet sieve cutter 26, as illustrated in FIG. 16.

The configuration further enables that any solids 4B and liquids 4C, which are unwanted for entry into the separation chamber (e.g. the seeds from a mango, or solid impurities, or tools, which have entered the feed by mistake, and liquids), may be separated by the wet sieve cutter, blades, and vacuum, and discharged at separate outlets, as illustrated in FIG. 16. For example, the mango seeds 4B may be transported to a separate outlet 4B and discharged by the blades, as illustrated in FIG. 16. Also, any free mango liquid 4C may be separated by the vacuum, and tapped at a separate outlet 4C, as illustrated in FIG. 16, and e.g. discharged and recycled as fluid inlet within another chamber or at a different location within the device. To further improve the recyclability of the discharged fluid, the fluid may be temperature controlled. Hence, the tapping area advantageously comprises a temperature regulating element, such as one or more heating and/or cooling elements. Hence, the apparatus further facilitates separation into multiple phases.

Chambers

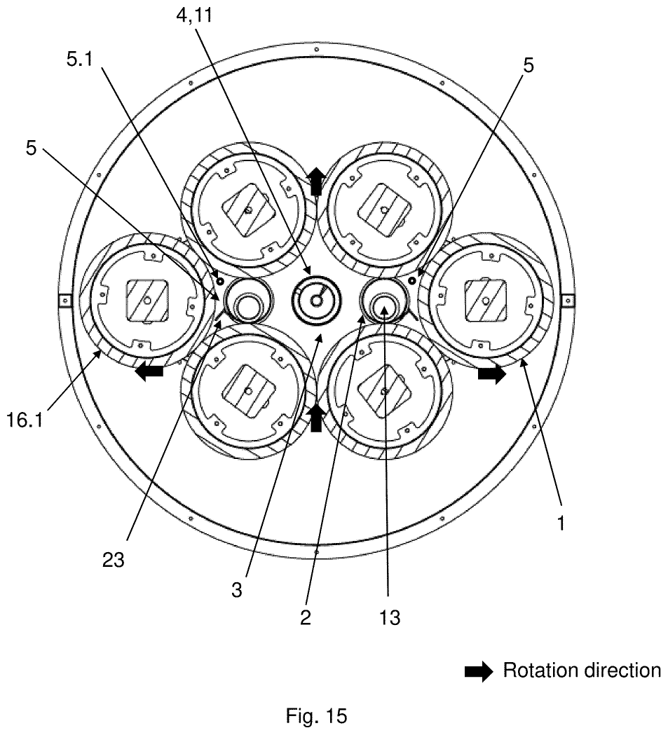

The device of FIGS. 1-4, 15 are seen to comprise at least one separation chamber 3 and at least one filtrate chamber 5. The filtrate chamber is defined in cross section by the press rollers 1 and the pore roller 2. The separation chamber may be defined as the volume in physical contact with the parts of the press rollers and the at least one pore roller, which is not defining the filtrate chamber. For example, the separation chamber may be defined in cross section by press rollers and the at least one pore roller, as exemplified in FIGS. 3 and 15, or defined in cross section by a housing, the at least one pore roller, and two or more press rollers, as exemplified in FIG. 1.

In an embodiment of the disclosure, the separation chamber is defined in cross section by press rollers and the at least one pore roller. In another embodiment, the separation chamber is defined in cross section by a housing, the at least one pore roller, and two or more press rollers.

From the separation chamber 3, a medium may pass between a set of abutting press roller and pore roller into the filtrate chamber 5. For example, the medium passes between an abutting press roller and pore roller, when the rollers are in rotation as exemplified by the arrows in FIGS. 1 and 15, The interface between the abutting press roller 1 and pore roller 2 is configured as a first filtration boundary 8, where liquid is squeezed out of the passing medium, and into the interior of the pore roller 2. Advantageously, the interior of the pore roller may function as pore roller liquid outlet 6, such that the risk of rewetting is reduced. Thus, at the first filtration boundary 8 the passing media may be separated into a first liquid fraction or a first filtrated liquid, and a first solid fraction or a first dry filter cake, where the first liquid fraction is transferred into the interior of the pore roller, and the first solid fraction is transferred into the filtrate chamber 5.

The first solid fraction may subsequently be passed between a set of abutting press rollers 1. The interface between the abutting press rollers is configured as a second filtration boundary 9, separating the first solid fraction into a second liquid fraction and a second solid fraction. The second liquid fraction may be squeezed back into the filtrate chamber 5, whereas the second solid fraction may pass between the press rollers and into the dry matter outlet 7. Thus, at the second filtration boundary 9 the first solid fraction, or first dry filter cake, may be further separated into a second liquid fraction, or second filtrated liquid, which is restricted to the filtrate chamber 5, and a second solid fraction, or second dry filter cake, which is transferred to the dry matter outlet 7, and where the second solid fraction has a lower liquid content than the first solid fraction.

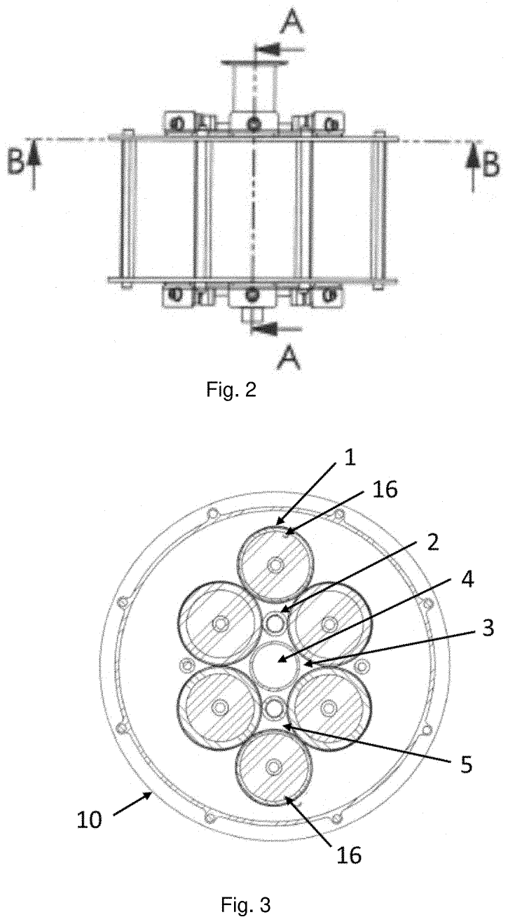

FIG. 1 shows an embodiment of the device comprising three press rollers 1, where the press rollers in cross section define only a part of the separation chamber. FIGS. 2-4, 15 show another and further embodiment of the device comprising six press rollers 1 and two pore rollers 2. In FIGS. 3 and 15, the press rollers and pore rollers are seen to define both the filtrate chamber 5 and the separation chamber 3 in cross section.

It follows that any number and combination of press rollers 1 and pore rollers 2 may be applied. Increasing the number of pore rollers 2, has the advantage of increasing the separation output capacity of the apparatus, since it corresponds to increasing the area of the first filtration boundary 8. Hence, a higher production rate of the first liquid fraction may be obtained.

Increasing the number of press rollers 1 also has the advantage of increasing the separation output capacity of the apparatus, since it corresponds to increasing the area of the second filtration boundary 9. Hence, a higher production rate of the second solid fraction may be obtained. Furthermore, by increasing the number of press rollers 1, a separation chamber defined in cross section by at least some of the press rollers and the at least one pore roller may be obtained, as illustrated in FIGS. 3 and 15, where the separation chamber 3 is defined in cross section by four press rollers 1 and the two pore rollers 2.

A separation chamber defined by press rollers and pore rollers has the advantage of reducing the amount of gaskets needed, and further simplifying the device and the maintenance of the device. For example, by simply removing or translating one or more press rollers, the pore rollers, feed inlet and grinder are easily accessed and exchanged, as seen in FIGS. 2-3. To further improve the simplicity and maintenance friendliness of the device, one or more of the press rollers and/or pore roller are advantageously detachably mounted in the device, e.g. by use of clamps.

To improve the cost-efficiency and simplicity of the device, the number of parts, including the number of rollers, are advantageously kept at a minimum. A high separation output capacity, in combination with a minimum of rollers, is seen for the apparatus having the roller configurations shown in FIGS. 1-4 and 15.

In an embodiment of the disclosure, the apparatus comprises at least three press rollers. In another and/or further embodiment of the disclosure, the separation chamber is defined in cross section by press rollers and the at least one pore roller. In a further embodiment, the apparatus comprises at least six press rollers, and at least two pore rollers.

The diameter of the at least one pore roller is advantageously sufficiently smaller than the diameters of the press rollers, whereby a simple and compact apparatus may be obtained. FIG. 3 shows an embodiment of the filtration device according to the present disclosure, comprising six press rollers 1 and two pore rollers 2, where the dimensions and diameters (Ø) may be inferred. Advantageously, the diameter of the pore roller is at least half or a quarter of the diameter of the press rollers. For example, the diameter of the press rollers may be between 50-100 mm, more preferably between 65-85 mm, such as 77 mm, and the diameter of the pore roller may be between 10-40 mm, more preferably between 15-35 mm, such as 25 mm. Preferably the diameter of the feed inlet or outer grinder filter is dimensioned to fill out as much of the separation chamber as possible, to improve the feed efficiency. For example, the diameter of the feed inlet or outer grinder filter may be between 10-80 mm, more preferably between 30-60 mm, such as 43.5 mm.

In an embodiment of the disclosure, the diameter of the at least one pore roller is at least 50% smaller than the diameter of the press rollers, more preferably at least 60% or 70% smaller, and most preferably at least 75% smaller.

The first solid fraction is transferred into the filtrate chamber 5, and then subsequently passed between the press rollers to exit the filtrate chamber. To further aid the movement of the solid fraction between the press rollers, and preferably to aid the movement of selected solid parts of solid fraction, the filtrate chamber advantageously comprises a fluid inlet for introducing a predefined gas, e.g. air, or liquid into the filtrate chamber. Hence, the supply of gas, air, and/or liquid into the filtrate chamber may be regulated by any known means such as pumps and/or valves. FIG. 15 shows a cross sectional top view of an embodiment of the filtration device, where the two filtrate chambers comprise a fluid inlet 5.1. For example, gas or air may be supplied for aerating or drying the material within the filtrate chamber, and liquid may be supplied for washing the material within the filtrate chamber.

In an embodiment of the disclosure, the filtrate chamber comprises a fluid inlet.

Sealant

The press rollers may comprise gaskets or sealants around the ends of the rollers. Alternatively, or additionally, the housing may comprises gaskets and/or sealants, such that the separation chamber is sealed. FIG. 4 shows an embodiment, where the cylindrical housing comprises a sealant 17.

In an embodiment of the disclosure, the apparatus comprises a housing at least partly surrounding the rollers, wherein the housing walls comprise a sealant.

FIGS. 2 and 4 show a side view and a cross sectional side view of an embodiment of the filtration device according to the present disclosure, comprising six press rollers and two pore rollers. The longitudinal direction of the rollers are exemplified as being vertically oriented, however it follows that the orientation of the rollers, including the housing and the device, may be horizontally or positioned at an angle, since the separation process does not depend on gravity. Hence, the filtration device has the advantage of a flexible device, which may be oriented independently on how the medium is received. It follows that the device may have any orientation, and advantageously is tiltable into any orientation, such as vertically or horizontally, and any angle therein between. Thus, the transport of feed and separated phases into and out of the device may be aided by e.g. gravity via the orientation.

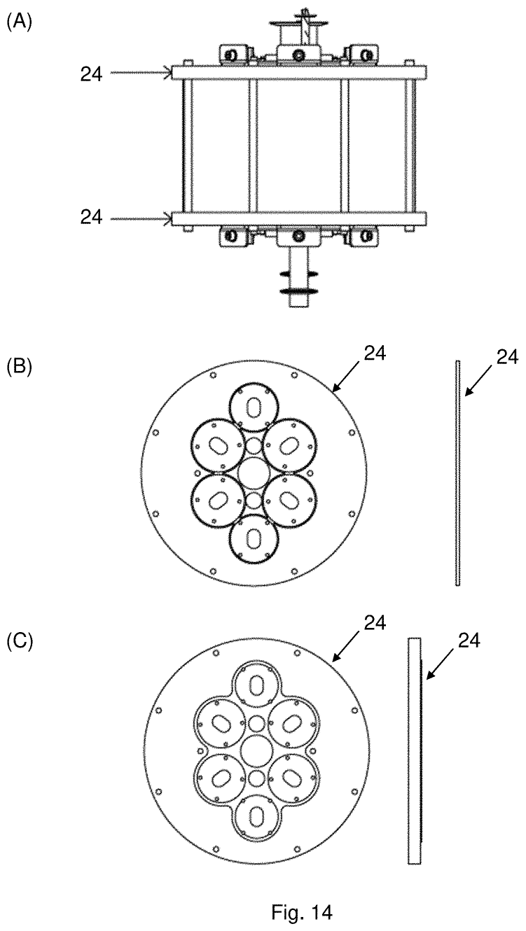

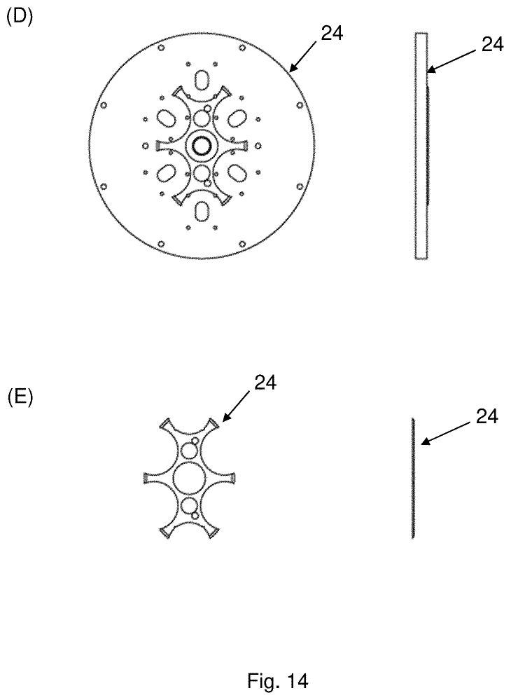

A simple housing with fewer parts, includes a housing comprising two end plates 24 abutting at least the press roller ends, as illustrated in FIG. 14A. The end plates may also be referred to as filter plates, and are located at the top and bottom of the machine, for a machine with vertically oriented press rollers as exemplified in FIG. 14A. The end plates are further advantageously configured to ensure a liquid or watertight seal between the separation chamber and the surroundings, e.g. by the end plates comprising a depression at the contact with the roller ends. Hence, the part of the end plate in contact with the separation chamber forms an elevated platform that is sealed from the surrounding depressed part of the end plate.

In an embodiment of the disclosure, the housing comprises two end plates abutting the roller ends. In a further embodiment, the end plates are configured as sealant for the roller ends.

The surface structure or roughness, including the depression and elevated platform of the end plates, may be obtained by milling a stainless steel plate, or milling a polymer plate, such as polyethylene (PE). The structured end plates may be attached, e.g. bolted, to a supporting back plate, for improving the mechanical structure and for easier manufacture. The design of the end plates further has the advantages of easy service and maintenance, including cleaning without disassembly, as well as reduced friction upon rotation of the rollers, thereby improving the performance of the rotation means, e.g. a driving motor.

FIGS. 14B-E show different embodiments of an end plate, as seen in top view (left) and in cross section (right). For example, the end plate may comprise a depressed pattern, or a milled pattern, that is an O-ring pattern, as shown in FIG. 14B; a pattern following the exterior circumference of the press rollers in contact with the surroundings, as shown in FIG. 14C; a pattern following the interior circumference of the press rollers in contact with the separation chamber, as shown in FIG. 14D. Alternatively, the elevated platform part may be manufactured separately, and attached to a supporting back plate, as shown in FIG. 14E.

In an embodiment of the disclosure, the end plates comprise a protruding platform for sealingly engaging a section of the roller end circumference. In a further embodiment, the end plates comprise a polymer, such as polyethylene (PE), and/or stainless steel.

Due to the sealingly engagement between the protruding platform and the rollers upon rotation, the protruding platform may be prone to wear. As the size of the protrusion is reduced, the sealing engagement is reduced, and there is a risk of leaks between the separation chamber and the surroundings. Hence, advantageously, the apparatus comprises a sensor for detecting changes in the dimensions of the sealant, e.g. the height of the protrusion.

In an embodiment of the disclosure, the apparatus comprises a sensor for detecting changes in the dimensions of the sealant.

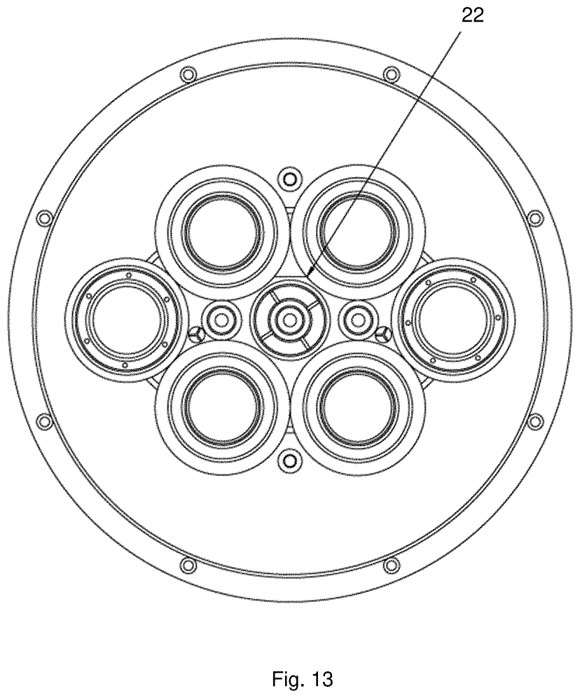

The end plates configured as sealant for the roller ends, provide a simple and efficient sealant for the separation chamber. Thus, the apparatus of the disclosure may be oriented in any orientation during operation, e.g. the device and the rollers may be oriented vertically, horizontally, or at any angle therein between. In addition to the feed material pressure, the operation may be enhanced by using hydrostatic pressure. FIGS. 12-13 show embodiments of the apparatus according to the present disclosure, where the rollers are oriented horizontally, such that the separation chamber comprises a liquid line, or waterline 22, which will provide an additional hydrostatic pressure to the separation process.

In an embodiment of the disclosure, the rollers are configured to be oriented horizontally.

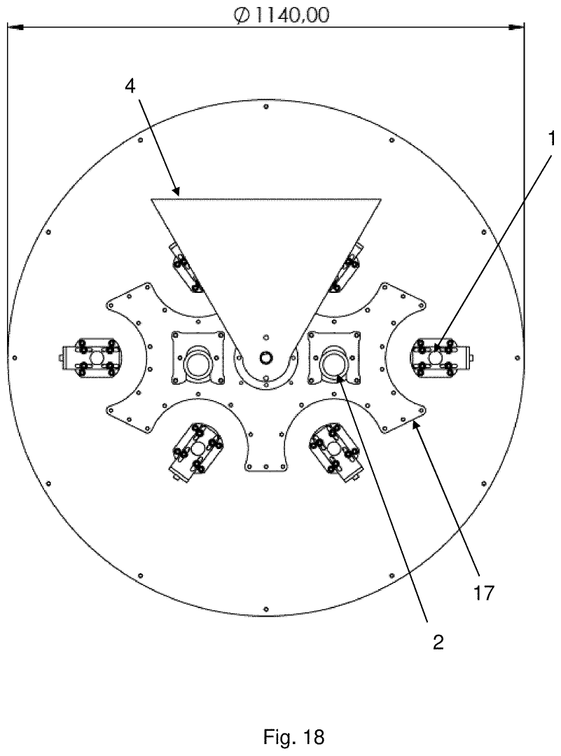

FIGS. 17-18 show embodiments according to the present disclosure of the filtration device in perspective view and perspective side view. The diameter (Ø) of the filtration device housing is exemplified to be 1140.00 mm, and the end plate including the sealant 17 is shown. It follows that the illustrated orientation of the filtration device is an example, and that the device may have any orientation, and advantageously is tiltable into any orientation, such as vertically or horizontally, and any angle therein between.

For assembly and disassembly, e.g. for service and maintenance of the apparatus, the sealants are advantageously detachably attached to the end plates, the rollers, and/or the housing, e.g. by use of fastening means such as clamps. Further advantageously, the fastening means include a spring force, such that a tight sealant configuration is ensured even when the dimension of the sealant changes during operation due to wear. This further facilitates digital monitoring and control of the sealants.

Operation

When the press rollers and pore rollers are rotating, the medium fed to the separation chamber will be separated by the device. Due to the rotation, the medium fed to the separation chamber 3 will first pass between a set of abutting press roller and pore roller, i.e. the first filtration boundary 8. At this boundary, liquid is squeezed out of the passing medium, and into the interior of the pore roller. Advantageously, the interior of the pore roller may function as pore roller liquid outlet 6, such that the risk of rewetting is reduced. Thus, at the first filtration boundary the passing media is separated into a first liquid fraction or a first filtrated liquid, and a first solid fraction or a first dry filter cake, where the first liquid fraction is transferred into the interior of the pore roller, and the first solid fraction is transferred into the filtrate chamber 5.

Due to the rotation, the first solid fraction is subsequently passed between a set of abutting press rollers 1. The interface between the abutting press rollers is configured as a second filtration boundary 9, separating the first solid fraction into a second liquid fraction and a second solid fraction. The second liquid fraction is squeezed back into the filtrate chamber 5, due to the impermeable nature of the surface of the abutting press rollers, whereas the second solid fraction passes between the press rollers and into the dry matter outlet 7. Thus, at the second filtration boundary the first solid fraction, or first dry filter cake, is further separated into a second liquid fraction, or second filtrated liquid, which is restricted to the filtrate chamber, and a second solid fraction, or second dry filter cake, which is transferred to the dry matter outlet, and where the second solid fraction has a lower liquid content than the first solid fraction.

The two separation steps provides increased separation efficiency including reduced risk of rewetting the separated solid fractions, and a second solid fraction with a surprisingly high dry matter content, such as at least 50 vol %, may be obtained.

In an embodiment of the disclosure, a method for separating dry matter and liquid from a medium is provided, comprising the steps of:
passing the medium between at least one set of abutting pore roller and press roller, thereby obtaining a first solid fraction and a first liquid fraction, and
passing the first solid fraction through at least one set of abutting press rollers, thereby obtaining a second solid fraction and a second liquid fraction.

Advantageously, the method is carried out in the apparatus of the present disclosure, and vice versa, the apparatus of the present disclosure is advantageously adapted for the disclosed separation method.

A roller is inherently adapted for rotating. The rotation of the press rollers and pore rollers may be obtained by one or more of the rollers being actively driven, e.g. by a motor. The actively rotating roller(s) may then drive the rotation of the neighbouring rollers, and the neighbouring's neighbour rollers, due to the rollers being abutting. Hence, an actively driven roller may drive one or more abutting neighbouring passive rollers, where a passive roller is not actively driven, but merely adapted for rotating, and where the rotation may be actuated by an abutting roller that is in rotation. The actively driven roller may further actuate rotation of the passive neighbouring's further passive neighbours, which are abutting. Thus, an actively driven roller may initiate a chain reaction of rotating passive rollers in the manner of a domino effect. For efficient and synchronous rotation, preferably at least one press rollers is configured as an active roller. The active press rollers are further advantageously rotated by a motor, which is a geared motor, such as a drum motor comprising planet gears. Hence, efficient and adjustable rotation may be obtained. A drum motor further has the advantage of being cost efficient, robust, clean, and maintenance friendly. FIG. 4 shows an embodiment, comprising two active press rollers 19.

In an embodiment of the disclosure, at least one press roller is an active roller, and optionally the at least one active press roller is rotated by a motor, optionally a geared motor, such as a drum motor.

To further improve the separation efficiency, two or more abutting rollers are advantageously active rollers, and/or adapted to rotate at different speed, such that shear forces occur at the filtration boundary between the abutting rollers.

In an embodiment of the disclosure, at least two rollers are active rollers, and preferably wherein the rollers are adapted to rotate at different speed.

Hence, the apparatus for the separation of dry matter and liquid from a medium, comprises:
a plurality of press rollers and at least one pore roller, wherein at least one press roller is configured as an active roller,
at least one separation chamber for receiving the medium,
at least one filtrate chamber defined in cross section by press rollers and the at least one pore roller, wherein the apparatus is configured to establish a relative negative pressure inside the pore roller, such that the liquid in the medium is sucked into the pore roller, and the dry matter of the medium is first passed between the pore roller and a press roller, and then passed between two press rollers, when the at least one press roller is active.

The operation of the apparatus may advantageously be partly or fully digitalized. For example, the rotation direction and rates of the grinder unit, transport unit, press rollers and pore rollers may be controlled via a user interface. Further advantageously, the user face includes controls for the grinder unit parameters, such that a certain cutting degree is obtained, e.g. a certain uniform sized particles or agglomerates. In addition the user face advantageously includes controls for the flow and directions of gasses and liquids within the system, such that a certain dry matter content may be requested at the feed, e.g. by adding fluids to the feed.

Press Roller

A press roller is a roller with a continuous and/or impermeable surface of the roller area. A press roller can be a solid roller or can comprise an inner small roller with a corresponding larger outer press shell arranged around the inner roller thereby enclosing the inner roller. The continuous and/or impermeable surface of the press roller can be provided in for example rubber, plastic, polymer or metal, such as stainless steel and nylon, or a mix thereof. For example, an embodiment of a press roller may include a core of metal, such as steel and an outer layer of rubber, or a core made from hard rubber and an outer layer made from rubber being softer than the core rubber. The shore value of the rubber may be between 20 and 95, such as between 60 and 90.

The continuous and/or impermeable surface of the press rollers entail that only the separated solid fraction will pass between abutting press rollers, or between abutting press roller and pore roller. The separated liquid fraction will, due to the pressure exerted by the rollers, either be guided into the interior of the pore roller via the pores on the surface, or be squeezed back away from the abutting rollers.

To aid the movement of the solid fraction between the press rollers, one or more of the press rollers advantageously comprises a non-smooth surface, i.e. a part of the roller surface has an irregular surface, such as a grooved surface. The grooved surface may further comprise regularly spaced grooves, such that the roller appears as gear shaped as seen in cross section.

In an embodiment of the disclosure, at least one of the press rollers comprises an irregular surface. In a further embodiment, at least one of the press rollers comprises a grooved surface. In a further embodiment, at least one of the press rollers comprises a surface with regularly spaced grooves, optionally wherein the surface is gear shaped.

To retain that it is still mainly the solid fraction, which is permitted passage between abutting rollers, two abutting rollers advantageously comprises matching surfaces, e.g. shaped as meshing gears. Thus, the at least one press roller comprising an irregular surface is abutting a roller, i.e. a press roller and/or pore roller, with a matching irregular surface. Alternatively, the matching irregular surfaces are configured to be synchronous, such that they are non-meshing gears, but instead a groove of the first roller abuts a groove of the second roller, and a protrusion of the first roller abuts a protrusion of the second roller. This way an improved contact force between the abutting rollers, and particularly the abutting protrusions, may be obtained.

A non-smooth surface of the press rollers further has the advantage that the separated dry matter may be easily removed from the apparatus after the separation operation. For example, the separated dry matter which have passed two press rollers with an irregular surface may be easily released to the housing without the use of an external scraping element. The separated dry matter may further be removed from the housing by the pressure within the housing, and/or snailed out by use of a scraping element, such as a helix shaped scraping element, and/or snailed out by the pattern of the irregular surface, e.g. a teeth patterned surface.

In an embodiment of the disclosure, at least two of the press rollers comprises an irregular surface. In a further embodiment, the at least one press roller comprising an irregular surface is abutting a roller with a matching irregular surface. In a further embodiment, the at least one press roller comprising an irregular surface is abutting a press roller with a matching irregular surface. In a further embodiment, the matching irregular surfaces are meshing gears or non-meshing gears.

FIG. 3 shows an embodiment, where at least two press rollers comprises an irregular press roller surface 16. The irregular surface has the advantage of providing efficient transport of the second solid fraction from the filtrate chamber and into the housing 10, where it may be further discharged from the housing and into an external chamber and/or the surroundings, e.g. through one or more side plates of the cylindrical housing.

To further aid the movement of the solid fraction between the press rollers, as well as to aid the movement of selective solid fractions between the press rollers, and further away from the press rollers, the press rollers advantageously comprise a temperature regulating element. For example, the press rollers may comprise a heating/cooling element, such as a jacket 16.1, in thermal communication with a part of the press roller circumferential surface, whereby the temperature of the press roller is controlled, and hence the temperature of the solid fraction exiting the filtrate chamber can be regulated and controlled. For efficient thermal communication, at least a part of the surface of the press roller comprises metal, whereby the solid fraction may be cooled or heated when exiting the filtrate chamber.

In an embodiment of the disclosure, the at least one press roller comprises a temperature regulating element. In a further embodiment, the temperature regulating element is

Pore Roller

A pore roller, also referred to as a filter roller, is a roller with a liquid permeable surface of at least a part of the roller area in contact with the press roller. An example of a filter roller is a pore roller disclosed in for example WO 2008/131780 and WO 2014/198907 where fluid is sucked through pores extending transversely, or radially, in the roller.

A filter roller can also comprise a filter roller with a recess in the surface and a filter shell enclosing the filter roller, the recess and the filter shell thereby creating a narrow filtration boundary. A filter roller can also comprise a small inner roller enclosed by a larger filter shell. In case of a filter shell it is the surface of the filter shell that is permeable.

The at least one pore roller is a roller comprising pores extending from the surface of the roller to at least one channel extending in said roller, preferably extending axially in said roller. Thus, the channel extending axially in the roller may function as pore roller liquid outlet 6. The size of the pores is preferably adjusted to a particle size of the dry matter to be separated. Thus, in one embodiment the pore roller has a pore size of at the most 5 mm, such as at the most 4 mm, for example at the most 3 mm, such as at the most 2 mm, for example at the most between 1 mm, such as at the most 75 μm, for example at the most 50 μm, such as at the most 25 μm, for example at the most 10 μm, such as at the most 1 μm, for example at the most 0.5 μm, for example at the most 0.1 μm, for example at the most 0.05 μm, for example at the most 0.01 μm. The size of the pores may be substantially identical along the radial direction of the roller, or the pore may extend into a wider groove when the pore reaches the outer surface of the roller or the inner surface of the roller in the channel.

The pore roller may be made from any suitable material, such as metal, rubber, plastic, including nylon, ceramics, and glass. To reduce material costs and weight of the device, the pore roller may be hollow, for example shaped as a hollow cylinder. Alternatively, the pore roller may have an outer part comprising the pores, which is made from a first material, such as metal, rubber, plastic, including nylon, ceramics, and/or glass, and an inner core part made from a second material, such as metal, rubber, plastic, including nylon, ceramics, and/or glass. It was found that a robust pore roller with efficient filtration may be obtained by use of pore roller shaped as a hollow cylinder, and comprising ceramic carbide, such as silicon carbide (SiC).

In an embodiment of the disclosure, the pore roller comprises a hollow cylinder, optionally comprising silicon carbide (SiC), and preferably wherein the hollow cylinder consists of silicon carbide.

The pore roller may be connected to means for pressurizing the system or pressure control means, for example so that a relative positive or negative pressure, such as vacuum, may be applied to the one or more channels of the pore roller in order to pressurize the filtering system. Hence, the interior of a pore roller may be pressurized. FIG. 4 shows an embodiment, comprising pressurizing means or pressure control means 18. FIG. 15 shows an embodiment, where the pore roller comprises a channel in the form of cylindrical chamber extending along the length pore roller, where the channel is configured for being pressurized, e.g. comprising an underpressure relative to the exterior of the pore roller. For example, a hollow cylinder comprising silicon carbide is sufficiently robust to withstand vacuum. Advantageously, the pore roller is configured for comprising a relative negative pressure, such as vacuum which will be relatively lower compared to the surroundings, since this will aid guiding the filtrated liquid into the pores of the pore roller, and further to the liquid outlet. Thus, the risk of rewetting the dry filter cake may be further reduced.

In an embodiment of the disclosure, the pore roller is configured for comprising a relative negative pressure, such as vacuum.

Upon rotation of the pore roller, the filtrated liquid located near the surface area of the pore roller may contact the separated first solid fraction, and consequently cause rewetting of the solid fraction. As mentioned above, a negative pressure within the pore roller may aid in removing the filtrated liquid from the surface area of the pore roller to the liquid outlet.

In addition, or alternatively, a hollow pore roller may further comprise a scraping element for scraping or wiping the interior surface of the pore roller, thereby aiding in transferring the filtrated liquid away from the surface area and to the liquid outlet. The scraping element may be in the form of wiper, such as a windscreen wiper, or a rotating roller with a grooved surface. Alternatively, the scraping element is a scraper protrusion, e.g. a lip mounted on a rod, e.g. a tolerance rod, allowing for internal scooping/scraping as the rod is revolved or rotated. FIGS. 3-4 shows an embodiment, where the pore rollers are hollow, and hence comprise a pore roller interior 14 and the pore roller interior surface 15, which may be scraped.

In addition, or alternatively, the scraping element 23 may be located in contact with the part of the pore roller within the filtrate chamber, as illustrated in FIG. 15. Hence, the scraping element is adapted for scraping a part of the exterior surface of the hollow pore roller. Thus, any part of the first solid fraction which is adhering to the surface of the pore roller after passing the first filtration boundary, may be released into the filtrate chamber, and ready for further separation. The scraping element may be similar to the external scraping element described in the section below. For example, the scraping element may be a static scraper as illustrated in FIG. 15. Alternatively, or in addition, the scraping element may be in the form of a rotating spindle or auger with an irregular surface, or a roller with a grooved surface, as illustrated in FIG. 6. Advantageously, the scraping element has a helix shape, and extends through the chamber, such that the scraped dry matter is pulled out of the pore roller surface and/or chamber along the longitudinal axis of the scraping element, simultaneously with scraping the exterior pore roller. Advantageously, the apparatus comprises one or more scraping elements, e.g. both a helix shaped and static scraper, and/or both external and internal scrapers.

Further advantageously, the scraping element is in thermal communication with a temperature regulating element, such that the temperature of the removed dry matter may be controlled and regulated by removing or supplying thermal energy.

To further reduce the risk of rewetting the dry filter cake, or the first solid fraction, after it has passed the abutting pore roller and press roller, the separated filtrated liquid located near the surface area of the pore roller, is advantageously guided away from the surface area of the pore roller as fast as possible. For example, if the pore roller is a hollow cylinder, a part of the filtrated liquid will be located inside the pores at the surface and at the interior surface of the hollow cylinder.

In an embodiment of the disclosure, the pore roller comprises a scraping element, adapted for scraping at least a part of the interior and/or exterior surface of the hollow pore roller. In a further embodiment the pore roller comprises an inner scraping element, adapted for scraping at least a part of the interior surface of the hollow pore roller, In a further embodiment, the scraping element is selected from the group of: wiper, a rod comprising a protrusion, and a roller with a grooved surface.

To ensure efficient separation and removal of the filtrated liquid, the pore roller advantageously comprises a pore roller liquid outlet 6, from where the filtrated liquid is transferred away from the pores and pore roller channel(s). Optionally, the pore roller liquid outlet comprises a pore roller liquid outlet chamber 13, as illustrated in FIG. 4. The liquid outlet may be in fluid communication with a storage or drainage system, e.g. the sewage. The liquid outlet may also be in fluid communication with the grinder unit, and subsequently be drawn out via the grinder into a storage unit or drainage unit. This has the advantage that the separated liquid may be re-used for the grinding process. Furthermore, more efficient drainage may be obtained via a grinder.

In an embodiment of the disclosure, the pore roller comprises a pore roller liquid outlet. In a further embodiment, the pore roller liquid outlet is in fluid communication with the grinder unit.

To facilitate a hollow pore roller, the pore roller is advantageously a passive roller, where the rotation is driven by the abutting rollers. For efficient rotation, the passive roller is advantageously rotated by two abutting active press rollers. Thus, no rotation axis or shaft is needed for a passive roller. A passive pore roller further has the advantage of providing higher shear forces at the filtration boundary.

Alternatively, the pore roller may be an active roller comprising rotation means, e.g. a motor, configured to be placed externally to the pore roller, e.g. placed at one of the longitudinal ends of the roller. For example, the external motor may be a drum motor. The rotation means may further be configured to be passively operated, e.g. via a free run.

In an embodiment of the disclosure, the pore roller is a passive roller. In another embodiment, the pore roller is an active roller comprising rotation means configured to be placed externally to the pore roller. In a further embodiment, the rotation means comprise a free run.

External Scarping Element

The external surface of filters such as the cylindrical filter, the outer grinder filter, and the pore rollers, may be clogged during operation. Similarly, the external surface of the press rollers may risk adhesion of materials. To reduce the risk of clogging and material adhesion, the rollers and/or filters advantageously comprise an external scraping element 23, as illustrated in FIGS. 6 and 12 and 15. The external scraping element may be in the form of a rotating spindle or auger with an irregular surface, or a roller with a grooved surface, as illustrated in FIG. 6. Advantageously, the scraping element has a helix shape, and extends through the chamber, such that the scraped dry matter is pulled out of the roller surface and/or chamber along the longitudinal axis of the scraping element, simultaneously with scraping the rollers. Further advantageously, the scraping element is in thermal communication with a temperature regulating element, such that the temperature of the separated dry matter may be controlled and regulated by removing or supplying thermal energy. Alternatively, or in addition, the external scraping element may be a static scraper, as illustrated in FIG. 12, or bristles or brushes 23.1 placed adjacent to an end of the roller, as illustrated in FIG. 6. Advantageously, the apparatus comprises one or more scraping elements, e.g. both a helix shaped and static scraper.

In an embodiment of the disclosure, one or more of the rollers and/or filters comprise an external scraping element, adapted for scraping at least a part of the exterior surface of the roller and/or filter. In a further embodiment, the external scraping element is selected from the group of: a spindle, an auger, a static scraper, a roller with a grooved surface, bristles and brushes, optionally wherein the external scraping element is placed adjacent to an end of the roller(s).

### REFERENCE NUMBERS

1—Press roller
2—Pore roller
3—Separation chamber
4—Feed inlet
4A—Feed for separation chamber
4B—Separate outlet for solids in raw feed
4C—Separate outlet for liquids in raw feed
5—Filtrate chamber
5.1—Filtrate chamber fluid inlet
6—Pore roller liquid outlet
7—Dry matter outlet
8—First filtration boundary
9—Second filtration boundary
10—Housing
11—Transport unit and/or grinder unit
11.1—Cylindrical filter
11.2—Outer grinder filter
11.3—Grinder blades
12—Liquid inlet and/or outlet
13—Pore roller liquid outlet chamber
14—Pore roller interior
15—Pore roller interior surface
16—Press roller surface
16.1—Heating/cooling jacket
17—Sealant
18—Pressure control means
19—Active press roller
20—Clamp
21—Sliding adjuster
22—Waterline
23—External scraping element
23.1—Bristles or brushes
24—End plate or filter plate
25—Shaft for electric motor
25A—First shaft
25B—Second shaft
25C—Shaft connector element
26—Wet sieve cutter
27—Vacuum generator

Items

The presently disclosed may be described in further detail with reference to the following items.
1. Apparatus for the separation of dry matter and liquid from a medium, comprising:
   a plurality of press rollers and at least one pore roller,
   at least one separation chamber for receiving the medium,
   at least one filtrate chamber defined in cross section by press rollers and the at least one pore roller,
   wherein the apparatus is configured:
   for establishing a relative negative pressure inside the pore roller interior, such that liquid in the medium is sucked into the pore roller interior, and
   for roller rotation such that during separation operation dry matter of the medium initially passes between the pore roller and a press roller when transferring from the separation chamber to the filtrate chamber, and subsequently passes between two press rollers when exiting from the filtrate chamber.
2. The apparatus according to item 1, wherein the separation chamber comprises a feed inlet.
3. The apparatus according to item 2, wherein the feed inlet comprises a transport unit, such as a screw conveyor.
4. The apparatus according to any of the preceding items, wherein the separation chamber and/or the feed inlet is in fluid communication with a grinder unit, optionally the grinder unit is selected from the group of: rotating knives, ball mills, and roller mills.
5. The apparatus according to any of items 3-4, wherein the transport unit is further a grinder unit.
6. The apparatus according to any of items 3-5, wherein the transport unit comprises a liquid inlet and/or outlet.
7. The apparatus according to item 6, wherein the liquid inlet and/or outlet is configured to have a relative negative pressure, such as vacuum.
8. The apparatus according to any of items 4-7, wherein the grinder unit comprises a cylindrical filter configured as liquid outlet.
9. The apparatus according to item 8, wherein the cylindrical filter is a ceramic filter, such as a silicon carbide (SiC) filter with a pore size between 0.01-0.5 μm, more preferably between 0.1-0.3 μm, such as 0.2 μm.
10. The apparatus according to any of items 8-9, wherein the cylindrical filter is adapted to be rotatable in both directions around a cylindrical axis.
11. The apparatus according to any of items 8-10, wherein the grinder unit comprises one or more blades extending radially outwardly from and in a direction along the cylindrical axis.
12. The apparatus according to item 11, wherein the one or more blades extend along the cylindrical axis in a helical pattern.
13. The apparatus according to any of items 11-12, comprising between 2-8 blades, preferably 4 blades.
14. The apparatus according to any of items 11-13, wherein the blades are adapted to be rotatable in both directions around the cylindrical axis.
15. The apparatus according to any of items 8-14, wherein the grinder unit comprises an outer grinder filter surrounding the blades.
16. The apparatus according to item 15, wherein the outer grinder filter is a ceramic filter with a pore size between 1-10 mm, more preferably between 3-7 mm, such as 5 mm.
17. The apparatus according to any of items 8-16, wherein the cylindrical filter and/or the outer grinder filter is configured to have a relative negative pressure, such as vacuum.
18. The apparatus according to any of the preceding items, wherein the separation chamber is defined in cross section by press rollers and the at least one pore roller.
19. The apparatus according to any of items 1-17, wherein the separation chamber is defined in cross section by a housing, the at least one pore roller, and two or more press rollers.
20. The apparatus according to any of the preceding items, comprising at least three press rollers.
21. The apparatus according to any of the preceding items, comprising at least six press rollers, and at least two pore rollers.
22. The apparatus according to any of the preceding items, wherein at least one press roller is an actively driven roller.
23. The apparatus according to any of the preceding items, wherein at least one of the press rollers comprises an irregular surface.
24. The apparatus according to item 23, wherein at least one of the press rollers comprises a grooved surface.
25. The apparatus according to item 24, wherein at least one of the press rollers comprises a surface with regularly spaced grooves, optionally wherein the surface is gear shaped.
26. The apparatus according to any of items 23-25, wherein at least two of the press rollers comprises an irregular surface.
27. The apparatus according to any of items 23-26, wherein the at least one press roller comprising an irregular surface is abutting a roller with a matching irregular surface.
28. The apparatus according to any of items 23-27, wherein the at least one press roller comprising an irregular surface is abutting a press roller with a matching irregular surface.
29. The apparatus according to item 28, wherein the matching irregular surfaces are meshing gears or non-meshing gears.
30. The apparatus according to any of the preceding items, wherein the at least one press roller comprises a temperature regulating element.
31. The apparatus according to any of the preceding items, wherein the pore roller comprises a hollow cylinder, optionally comprising silicon carbide (SiC), and preferably wherein the hollow cylinder consists of silicon carbide.
32. The apparatus according to any of the preceding items, wherein the pore roller is configured for comprising a relative negative pressure, such as vacuum.
33. The apparatus according to any of items 31-32, wherein the pore roller comprises a scraping element, adapted for scraping at least a part of the interior and/or exterior surface of the hollow pore roller.
34. The apparatus according to any of items 30-31, wherein the pore roller comprises an inner scraping element, adapted for scraping at least a part of the interior surface of the hollow pore roller.
35. The apparatus according to item 33, wherein the inner scraping element is selected from the group of: wiper, a rod comprising a protrusion, and a roller with a grooved surface.
36. The apparatus according to any of the preceding items, wherein the pore roller comprises a pore roller liquid outlet.
37. The apparatus according to item 34, wherein the pore roller liquid outlet is in fluid communication with the grinder unit.
38. The apparatus according to any of the preceding items, wherein the pore roller is a passive roller.
39. The apparatus according to any of items 1-35, wherein the pore roller is an active roller, comprising rotation means configured to be placed externally to the pore roller.
40. The apparatus according to item 37, wherein the rotation means comprise a free run.
41. The apparatus according to any of the preceding items, wherein the at least one active press roller is rotated by a motor, optionally a geared motor, such as a drum motor.
42. The apparatus according to any of the preceding items, wherein at least two rollers are active rollers, and preferably wherein the rollers are adapted to rotate at different speed.
43. The apparatus according to any of the preceding items, wherein one or more of the rollers and/or filters comprise an external scraping element, adapted for scraping at least a part of the exterior surface of the roller and/or filter.
44. The apparatus according to item 41, wherein the external scraping element is selected from the group of: a spindle, an auger, a static scraper, a roller with a grooved surface, bristles and brushes, optionally wherein the external scraping element is placed adjacent to an end of the roller(s).
45. The apparatus according to any of the preceding items, further comprising a data processing unit configured for receiving input on the received medium, and optionally controlling the rotation means.
46. The apparatus according to any of the preceding items, further comprising a housing at least partly surrounding the rollers, wherein the housing walls comprise a sealant.
47. The apparatus according to item 44, wherein the housing comprises two end plates abutting the roller ends.
48. The apparatus according to item 45, wherein the end plates are configured as sealant for the roller ends.
49. The apparatus according to item 46, wherein the end plates comprise a protruding platform for sealingly engaging a section of the roller end circumference.
50. The apparatus according to any of items 46-47, wherein the end plates comprise a polymer, such as polyethylene (PE), and/or stainless steel.
51. The apparatus according to any of items 46-48, further comprising a sensor for detecting changes in the dimensions of the sealant.
52. The apparatus according to any of the preceding items, wherein the diameter of the at least one pore roller is at least 50% smaller than the diameter of the press rollers, more preferably at least 60% or 70% smaller, and most preferably at least 75% smaller.
53. The apparatus according to any of the preceding items, wherein the rollers are configured to be oriented horizontally.
54. The apparatus according to any of items 44-51, wherein the rollers, and/or grinder, and/or scraping elements are detachably attached to the housing or the end plates, such as by use of clamps, optionally in combination with one or more slidable adjusters.
55. The apparatus according to any of the preceding items, wherein the filtrate chamber comprises a fluid inlet.
56. A method for separating dry matter and liquid from a medium, comprising the steps of:
   passing the medium between at least one set of abutting pore roller and press roller, thereby obtaining a first solid fraction and a first liquid fraction, and
   passing the first solid fraction through at least one set of abutting press rollers, thereby obtaining a second solid fraction and a second liquid fraction.
57. The method according to item 53, further comprising a step of passing the medium through a grinder.
58. The method according to any of items 53-54, comprising a step of providing the apparatus according to any of items 1-52, and separating dry matter and liquid from the medium within the apparatus.
59. The apparatus according to any of items 1-52, adapted for the method according to any of items 53-54.
60. A grinder unit configured as a transport unit, and comprising a liquid inlet and/or outlet.
61. The grinder unit according to item 57, wherein the liquid inlet and/or outlet is configured to have a relative negative pressure, such as vacuum.
62. The grinder unit according to any of items 57-58 comprising a cylindrical filter configured as liquid outlet.
63. The grinder unit according to item 59, wherein the cylindrical filter is a ceramic filter, such as a silicon carbide (SiC) filter with a pore size between 0.01-0.5 μm, more preferably between 0.1-0.3 μm, such as 0.2 μm.
64. The grinder unit according to any of items 59-60, wherein the cylindrical filter is adapted to be rotatable in both directions around the cylindrical axis.
65. The grinder unit according to any of items 57-61, wherein the grinder unit comprises one or more blades extending radially outwardly from and in a direction along the cylindrical axis.
66. The grinder unit according to item 62, wherein the one or more blades extend along the cylindrical axis in a helical pattern.
67. The grinder unit according to any of items 62-63, comprising between 2-8 blades, preferably 4 blades.
68. The grinder unit according to any of items 62-64, wherein the blades are adapted to be rotatable in both directions around the cylindrical axis.
69. The grinder unit according to any of items 57-65, wherein the grinder unit comprises an outer grinder filter surrounding the blades.
70. The grinder unit according to item 66, wherein the outer grinder filter is a ceramic filter with a pore size between 1-10 mm, more preferably between 3-7 mm, such as 5 mm.
71. The grinder unit according to any of items 57-67, wherein the cylindrical filter and/or the outer grinder filter is configured to have a relative negative pressure, such as vacuum.

1. Apparatus for the separation of dry matter and liquid from a medium, comprising:
a plurality of press rollers and at least one pore roller,
at least one separation chamber for receiving the medium,
at least one filtrate chamber defined in cross section by press rollers and the at least one pore roller,
wherein the apparatus is configured:
for establishing a relative negative pressure inside the pore roller interior, such that liquid in the medium is sucked into the pore roller interior, and
for roller rotation such that, during separation operation, dry matter of the medium initially passes between the pore roller and a press roller when transferring from the separation chamber to the filtrate chamber, and subsequently passes between two press rollers when exiting from the filtrate chamber.

2. The apparatus according to claim 1, wherein the separation chamber comprises a feed inlet, a transport unit, and/or a grinder unit.

3. The apparatus according to claim 2, wherein the grinder unit comprises a cylindrical filter, and/or a liquid outlet.

4. The apparatus according to any of claims 2-3, wherein the grinder unit comprises one or more blades extending radially outwardly from and in a direction along a cylindrical axis, preferably in a helical pattern.

5. The apparatus according to claim 4, comprising between 2-8 blades, preferably 4 blades, and/or wherein the blades are adapted to be rotatable in both directions around the cylindrical axis.

6. The apparatus according to any of claims 2-5, wherein the grinder unit comprises an outer grinder filter surrounding the blades.

7. The apparatus according to any of claims 3-6, wherein the cylindrical filter and/or the outer grinder filter is configured to have a relative negative pressure, such as vacuum.

8. The apparatus according to any of the preceding claims, wherein the separation chamber is defined in cross section by press rollers and the at least one pore roller, or wherein the separation chamber is defined in cross section by a housing, the at least one pore roller, and two or more press rollers.

9. The apparatus according to any of the preceding claims, comprising at least three press rollers, more preferably at least six press rollers, and at least two pore rollers.

10. The apparatus according to any of the preceding claims, wherein at least one press roller is an actively driven roller.

11. The apparatus according to any of the preceding claims, wherein at least one of the press rollers comprises an irregular surface.

12. The apparatus according to any of the preceding claims, wherein the pore roller comprises a hollow cylinder, and preferably is configured for comprising a relative negative pressure, such as vacuum.

13. The apparatus according to any of the preceding claims, wherein one or more of the rollers and/or filters comprise an external scraping element, adapted for scraping at least a part of the exterior surface of the roller and/or filter.

14. The apparatus according to any of the preceding claims, further comprising a housing at least partly surrounding the rollers, wherein the housing walls comprise a sealant, and preferably wherein the rollers, and/or grinder, and/or scraping elements are detachably attached to the housing or the end plates, such as by use of clamps.

15. A method for separating dry matter and liquid from a medium, comprising the steps of:
passing the medium between at least one set of abutting pore roller and press roller, thereby obtaining a first solid fraction and a first liquid fraction, and
passing the first solid fraction through at least one set of abutting press rollers, thereby obtaining a second solid fraction and a second liquid fraction.
